(19) United States
(12) Patent Application Publication
(10) Pub. No.: US 2024/0301822 A1
(43) Pub. Date: Sep. 12, 2024

(54) Air compression system, requiring on mechanical compressor, electricity, or other external energy to operate

(71) Applicants: Robert Ray Lovett, Finger, TN (US); Donna Michelle Lovett, Finger, TN (US)

(72) Inventors: Robert Ray Lovett, Finger, TN (US); Donna Michelle Lovett, Finger, TN (US)

(21) Appl. No.: 18/445,023

(22) Filed: Mar. 9, 2023

(51) Int. Cl. F02C 6/16

(52) U.S. Cl. CPC F02C 6/16; F03G 7/122; F04B 43/1136

(57) ABSTRACT

An air compressor system includes: two or more compressed air tanks previously filled with compressed air; several compression chambers also filled with compressed air, each containing a small internal expandable tube; located inside a larger external heavy-walled tube bonded to endcaps containing one-way and two-way valves, rigidly attached to top and bottom outside tanks; a timed valve inside expandable tube allowing compressed air from top tank to expand that tube to inside of heavy-walled tube, compressing ambient air outside expandable tube that entered through one-way valves. A second timed valve opens, forcing the original air back into the tank bottom or for immediate use or storage. Several other compression chambers follow the same procedure nonstop, increasing the psi in tank for immediate use or storage. All FIG. 1A compression chambers share two common tanks, which fill from top tank 600 and empty in bottom tank 602 in sequence.

This application claims the benefit under 35 USC 119(e) of provisional application Ser. No. 63/372,993, titled “A closed computerized system for compressing atmospheric gas, requiring no mechanical air compressor, electricity, or other external energy.” Filed Apr. 22, 2022, by Robert Ray Lovett. All of the above listed US patent and patent applications are incorporated herein by reference in their entirety.

### BACKGROUND ART OF INVENTION

### Technical Field

Often regarded as the fourth utility after electricity, natural gas, and water. Compressed air is widely used in manufacturing facilities. Compressed air is the most useful and underappreciated tool used in industry. Cost for air compressors can account for up to 30% of a manufacturing site's total electric bill. Only about 5-10% of the energy input to a compressor goes toward productive use of compressed air based on useful work delivered. A 1-HP compressed-air motor consumes several times as much energy as a comparable 1-HP electric motor. Accounting for the physics and thermodynamics involved in operating said motor, compressing air is naturally inefficient. What's needed is a more economical way to compress atmospheric air using less clean energy. This patent defines a new and inexpensive way of compressing ambient air to many times atmospheric pressure, which makes it more economical to use, also surpassing wind and solar because of those sources' site limitations and limited availability.

### Description of the Prior Art

The first air compression came from our ancestor's human lungs to build fires followed by bellows, water wheels, then steam. The applicants found no past or current commercial air compression systems, that require no external energy to operate.

### BRIEF DESCRIPTION

Briefly, the present invention describes a disruptive innovation for compressing ambient atmospheric air from 14.7-psi up to 10,000-psi or higher, its operation requiring neither traditional compressor nor electricity. Clean energy is required to prevent further contamination of our atmosphere. With the mobility market shifting to electric vehicles, there is insufficient energy from solar and wind to meet present and future demands.

### BRIEF DESCRIPTION OF THE FIGURES

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates an exemplary system top and bottom views 106 and 108 of compression chamber 302 for compressing ambient atmospheric air to 10,000 psi or higher. One-way valve 100 regulates the psi pressure from tank 600, whereas the two-way valve 102 regulates the pressure entering tank 602 or released for immediate use or storage.

FIG. 1B illustrates an exemplary system side view [in a closed position] of an expandable tube 104, for compressing ambient atmospheric air by expanding and contracting through valves 100 and 102.

FIG. 1C illustrates an exemplary system with expandable tube 104, bonded inside compression chamber 302 [in a closed position]. One-way valve 100 and two-way valve 102 allow entry and exit of high-pressure gas, whereas one-way valves 300 allow ambient air to enter compression chamber 302.

FIG. 1D illustrates an exemplary system where 10,000-psi compressed gas is forced into expandable tube 104, from tank 600 through one-way valve 100, compressing ambient air outside tube 104 to 10,000-psi, which entered through one-way valves 300. Compressed gas may then exit through two-way valve 400 for immediate use or storage, or into tank 602 to be reused for all future compression cycles.

FIG. 1E illustrates expandable tube 104 returned to its [normally closed position], filling compression chamber 302 with new ambient air through one-way valves 300.

FIG. 2A details a top view of tank 600 with several FIG. 1A air compression chambers attached around periphery. Also shown are ambient air intake valves 300 and one-way valve 604.

FIG. 2B details how one-way valve 100 allows entry of 10,000-psi compressed air into FIG. 1A at top of tank 600, whereas two-way valve 102 allows exit of 10,000-psi air into FIG. 1A at bottom of tank 602 for immediate use or storage.

FIG. 3 shows a sixteen FIG. 1A compressor chamber installation.

### DETAILED DESCRIPTION

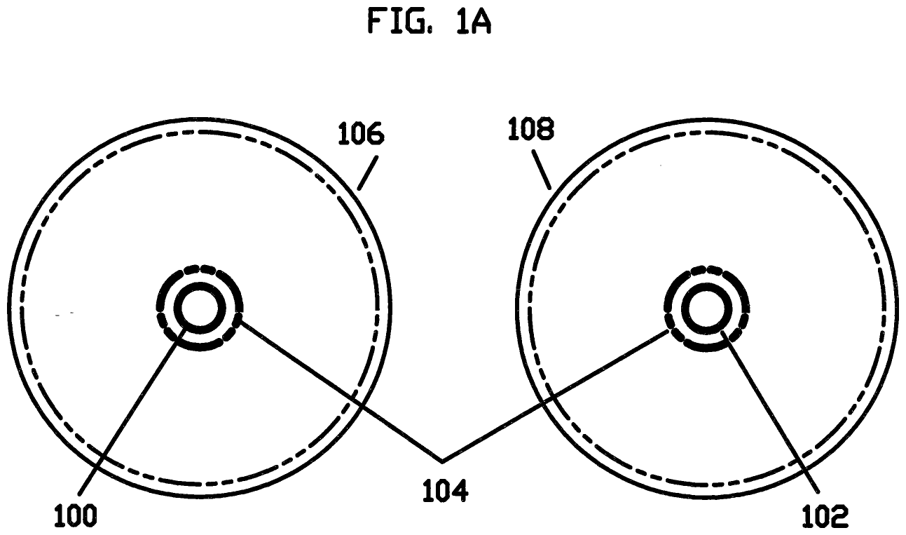

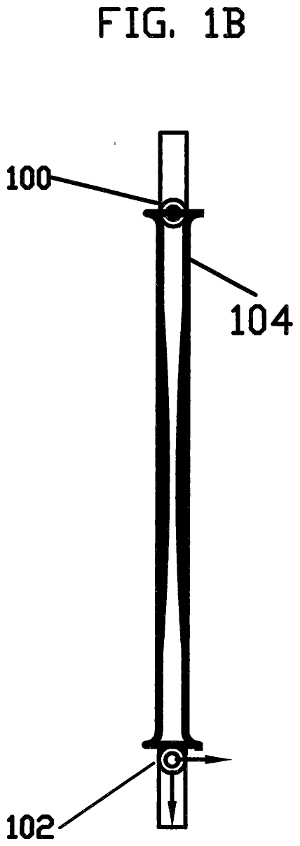

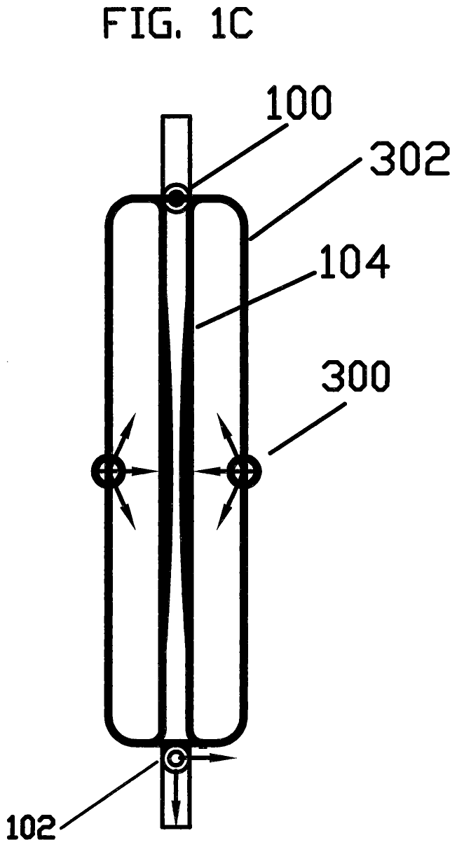

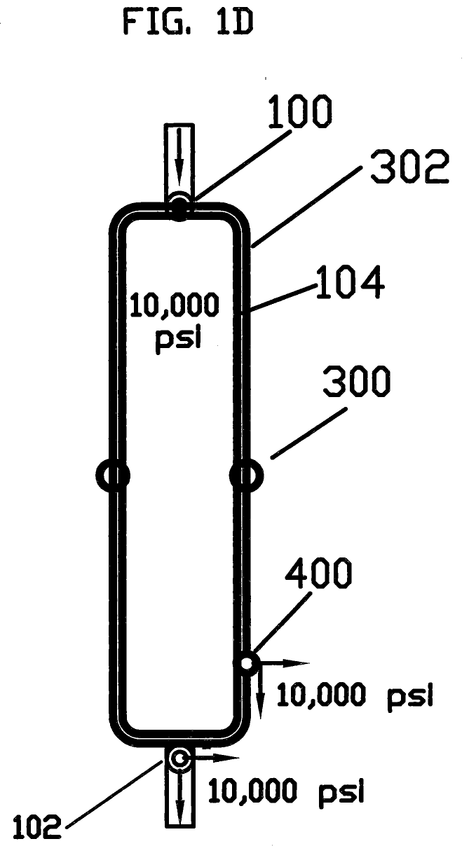

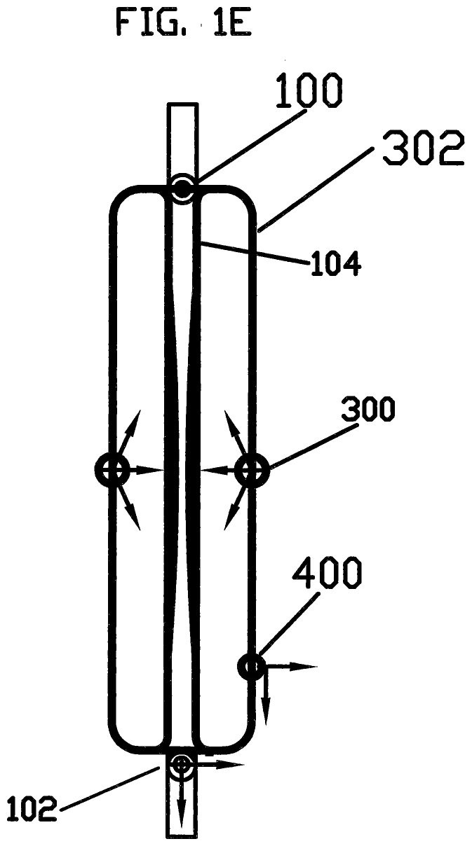

Referring to FIG. 1A illustrates an exemplary closed computerized system for capturing and compressing ambient atmospheric air to a much higher psi for use in industry, utilizing previously stored compressed air as its sole energy source.

FIG. 1A illustrates a top- and bottom-end view of valves 100 and 102, bonded to end caps 106 and 108 respectively, which allows compressed air to enter from tank 600 and exit into tank 602. Expandable tube 104 [shown in normally closed position] allows 10,000-psi compressed air to flow into inside tube 104 from tank 600, compressing ambient air on outside of expandable tube 104 to 10,000-psi, which enters through one-way valves 300. FIG. 1B illustrates a side view of expandable tube 104, which compresses ambient air to 10,000-psi inside compressor chamber 302. The center portion is designed to be stronger, utilizing springs, thicker material, material that holds or dissipates heat, or other creative ways, in order to force 10,000-psi gas out through two-way valve 102 into tank 602 or for immediate use or storage.

FIG. 1C illustrates one-way valves 300, which allow ambient air to enter inside chamber 302, filling all spaces around expandable tube 104 [in its closed position].

FIG. 1D illustrates computer-opened two-way valve 400, allowing ambient air now 10,000 psi to be released for immediate use or storage for [CCUS] or [CAES], or flow into tank 602 to control heat buildup for steam for hydrogen electrolysis or to increase tank psi value.

FIG. 1E illustrates expandable tube 104 closing to its [normally closed position], creating a vacuum inside compression chamber 302, which pulls in more ambient air through one-way valves 300. When used to power a pneumatic motor, the exhaust gas may also be diverted back into a FIG. 1A compression chamber 302 containing ambient air, through one-way valves 300, which has a much higher PSI than ambient air.

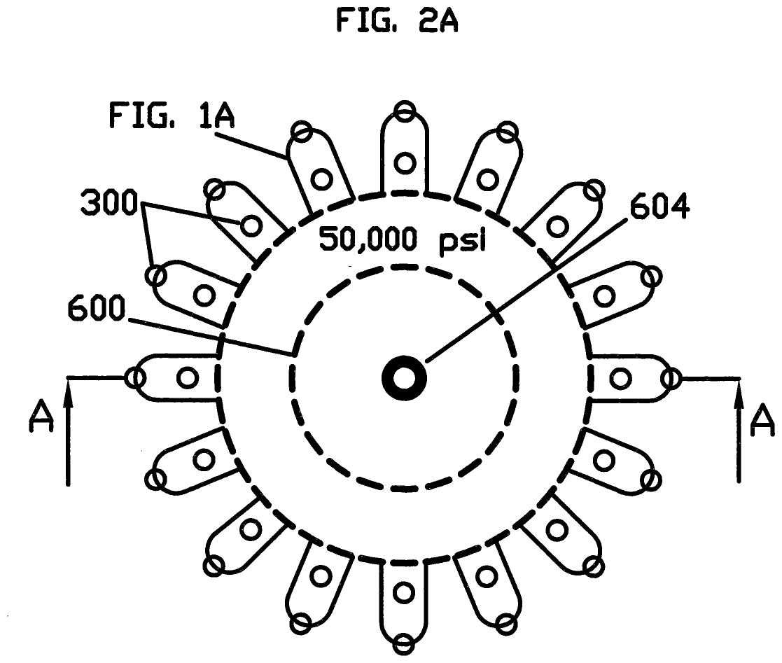

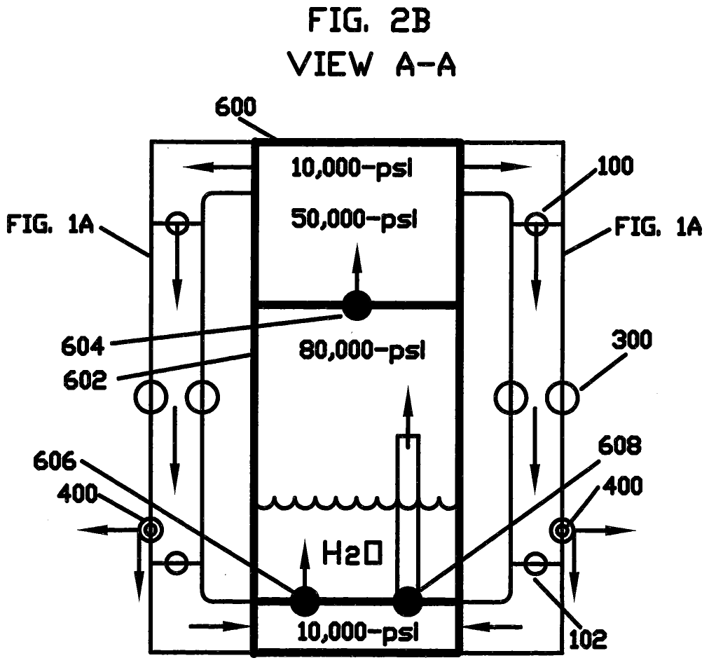

FIG. 2A details a top view of tank 600, with several FIG. 1A compressor chambers: six containing ambient air, and ten containing 10,000-psi equally spaced around outside periphery where ambient air enters through one-way valves 300, into outer surface of expandable tube 104. One-way valve 604 controls the minimum 50,000-psi pressure in tank 600.

FIG. 2B details one-way valve 100 in FIG. 1A opening, allowing entry of 10,000-psi compressed air from tank 600 into one or more FIG. 1A compression chambers 302, lowering the 50,000-psi normal operating pressure. Valve 604 automatically opens, allowing 80,000-psi pressure from tank 602 to flow into tank 600, bringing the pressure back to 50,000-psi, then closing. This, process prevents a much higher psi in tank 602 and tank 600 from equalizing. Valve 606 and 608 may increase or decrease pressure and or temperature of compressed air for electrolysis.

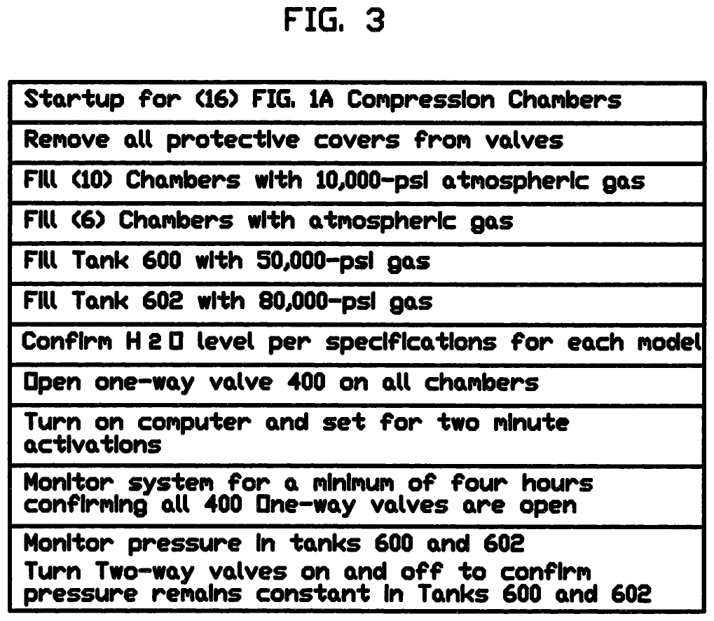

FIG. 3 shows a sixteen FIG. 1A compressor chamber installation drawing including safety procedures.

All FIG. 1A compression chambers 302 connected to tank 600 and tank 602 open then close sequentially, which makes 100,000-psi pressure always available on demand from tank 602 to refill tank 600.

In a preferred embodiment, this model provides an ambient air compression system for carbon capture, use, and storage [CCUS].

In a preferred embodiment, this model provides an ambient air compression system for compressed air energy storage [CAES].

In a preferred embodiment, this model provides an ambient air compression system for spinning a pneumatic linear generator utilizing a pneumatic motor.

1. An atmospheric air compression system for capturing and compressing ambient air up to 10,000 pounds per square inch (PSI) for immediate use or storage, utilizing previously stored compressed air as its sole energy source.

2. The system of claim 1, wherein up to one hundred percent of said previously stored compressed air is retained in system, and reused for all future compressions cycles or said compressed air is retained in a tank to control heat buildup for steam for hydrogen electrolysis or to increase the tank PSI.

3. The system of claim 1, wherein the system is used to power a pneumatic motor; wherein the pneumatic motor is powered by exhaust gas; wherein the exhaust gas is returned to a compression chamber containing ambient air via one-way valves. exhaust gas is diverted into a compression chamber containing ambient air the compression system has regenerative capabilities to refill compressed air in FIG. 1A compression chambers after repair or replacement requiring no mechanical air compression system.

4. The system of claim 1, wherein compressed air is used to generate electricity utilizing a turbine required for desalination and purification of fresh or seawater for electrolysis conversion to green hydrogen.

5. The system of claim 1, wherein compressed air is used for a Ranque-Hilsch vortex tube for off-grid heating and cooling residential homes and commercial buildings, and cool thousands of computer data centers globally saving billions of gallons of water annually.

6. The system of claim 1, wherein compressed air is used for a Ranque-Hilsch vortex tube for both lift and propulsion for lighter-than-air airships.

7. The compression system of claim 1, with its regenerative capabilities [becomes a closed or isolated system] that can supply energy on Earths Moon, Mars, and other celestial bodies for habitats, exploration, wireless recharging batteries & supercapacitors for rovers, habitats, exploration, construction, and communication by removing valves 300 and 400 on FIG. 1D and continually varying the compression chamber numbers used in FIG. 2A plus using a Ranque-Hilsch vortex tube to heat and cool air based on external biometric pressure and temperatures.

8. The system of claim 1, wherein the temperature of compressed air may be controlled by varying the number and sequence of FIG. 1A compression chambers used.

9. The system of claim 1, wherein a maneuverable satellite used for compressing thin air in lower earth orbit used for capturing and moving orbital space debris to a lower orbit to burn up on reentry or move to graveyard orbits.

10. According to claim 9, wherein the maneuverable satellite is used to capture and move existing satellites to a new vertical location to avoid onrushing space debris.

11. According to claim 9, wherein the maneuverable satellite become several “mother satellites” strategically located to relay-data back to ground stations in real time.

12. The system of claim 1, further comprising a feedback control system to automatically adjust the compression rate based on the demand for compressed air, ensuring optimal energy usage and storage efficiency.

13. The system of claim 2, wherein the retained compressed air is further used to generate electricity through an air turbine, the generated electricity being used to power the system's control electronics or for external applications.

14. The system of claim 2, further including a heat exchanger mechanism that utilizes the heat generated during the compression process for heating purposes in residential or commercial buildings, thereby enhancing the system's energy efficiency.

15. The system of claim 13, wherein the system includes multiple compression stages with intercooling between stages to increase the efficiency of air compression to (10,000) pounds per square inch.

16. The system of claim 15, wherein the system is equipped with a filtration system to remove contaminants from the ambient air prior to compression, ensuring the purity of the compressed air for specific industrial or medical applications.

17. The system of claim 2, wherein the system includes a monitoring interface that provides real-time data on system performance, including air pressure levels, temperature, and efficiency metrics, accessible remotely for maintenance and optimization.

18. The system of claim 17, wherein the compressed air retained in the tank is used as a backup power source for emergency services, providing a reliable energy supply in the event of power outages or disasters.
